(19) United States
(12) Patent Application Publication
(10) Pub. No.: US 2016/0377117 A1
(43) Pub. Date: Dec. 29, 2016

(54) LIMITED TORQUE ISOLATION BEARING

(71) Applicant: ZTI PRODUCTS, LLC, Cuyahoga Falls, OH (US)

(72) Inventor: DONALD P. POWDER, ROCHESTER HILLS, MI (US)

(21) Appl. No.: 14/774,363

(22) PCT Filed: Sep. 16, 2014
(86) PCT No.: PCT/US14/55754

§ 371 Date: Sep. 10, 2015

Related U.S. Application Data
(63) Continuation of application No. PCT/US2014/028802, filed on Mar. 14, 2014.

(51) Int. Cl. F16C 27/06; B60G 11/10; F16F 1/38; F16C 17/26

(52) U.S. Cl. CPC F16C 27/063; F16C 17/26; B60G 11/10; F16F 1/38; F16C 2326/05; F16C 2240/12; B60G 2204/121; B60G 2204/41; B60G 2204/418

(57) ABSTRACT

A zero or limited resistance isolation bearing comprising a tubular outermost sleeve, an elastic or resilient member located adjacent to and inside the outermost sleeve, and an innermost sleeve assembly consisting of a tubular inner member and a tubular outer member that are threadably interconnected. The threadable interconnections are properly sealed at the ends, and a lubricant is supplied in and around the threadable interconnections to allow zero or limited resistance to torsional rotation of the inner member of the innermost sleeve assembly relative to the outer member of the innermost threaded sleeve assembly. Such bearings are useful as automotive suspension components, such as, for example, for use in connective members of control arms at the automobile frame.

### RELATED APPLICATIONS

The present invention is the national stage entry in the US of PCT Serial No. PCT/US14/55754, filed Sep. 16, 2014, which was a continuation-in-part of PCT Serial No. PCT/US14/28802, filed Mar. 14, 2014, wherein the present application claims a benefit of the Mar. 14, 2014 priority filing date.

### FIELD OF THE INVENTION

The present invention relates to a zero or limited resistance isolation bearing comprising a tubular outermost sleeve, an elastic or resilient member located adjacent to and inside the outermost sleeve, and an innermost sleeve assembly offering no resistance to torsional motion that consists of a tubular inner member and a tubular outer member that are threadably interconnected and lubricated.

### BACKGROUND OF THE INVENTION

Isolation bearings consisting of an innermost and outermost metal sleeve with an elastomeric material therein between are well known in the art. Although inexpensive, these well-known devices do not allow free torsional rotation of the innermost metal sleeve relative to the outermost metal sleeve, as the elastomeric material therein between (which is normally compressed) acts as a binder to this torsional rotation. The torsional stiffness for these conventional, well-known devices falls in the range of about 3600 to 3800 N-m/deg. When these well-known, conventional devices are used as the attachment point for the lower control arm of a control arm assembly with the frame of a modern vehicle for example, the torsional stiffness effectively translates into an “effective” or “virtual” additional load of over 5 lbs. per wheel of unsprung weight. As is well-known, this additional unsprung weight degrades overall ride and handling. To alleviate the aforementioned torsional stiffness, prior art patents suggest the lubrication of the elastomeric material, or using patterned elastomeric material that will accept and retain a lubricant to allow for rotation of the isolation bearing, as in U.S. Pat. No. 5,100,114.

Other prior art isolation bearings utilize plastic inserts to allow for such rotation and to reduce noise or clatter in the metal-to-metal contacts. These isolation bearings suffer from a lack of durability, as the elastomeric or plastic material rapidly degrades under the radial loads normally experienced in modern vehicles. Isolation bearings that utilize plastic inserts are therefore constrained as they are limited to being used with light loads.

None of the prior art isolation bearings are inexpensive units that are durable and that allow for zero or limited resistance to torsional motion of the bearing. In addition, the prior art isolation bearings suffer from being noisy (metal-to-metal contact) or have low load limitations.

### SUMMARY OF THE INVENTION

In accordance with the present invention, an isolation bearing is provided that is specifically designed for limited or zero resistance to the torsional motion of the innermost sleeve to the outermost sleeve for use in such applications as vehicle suspensions that includes, in combination, an overall concentric arrangement of a tubular outermost sleeve (or vehicle component part), a multicomponent tubular innermost sleeve assembly, and an elastic component that is at least partially compression fitted therein between the tubular outermost sleeve and the multicomponent tubular innermost sleeve assembly. The multicomponent innermost sleeve assembly comprises a tubular inner sleeve member and a tubular outer sleeve member that are threadably interconnected, which threadable interconnection contains at least some void space to allow for and to accept a lubricant. Optionally, the threads of the threadable interconnection may include flattened, or truncated, raised portions to supply the source of the void space. Sealing means at the ends of the tubular sections of the multicomponent tubular inner most sleeve assembly to minimize the loss of the lubricant is also provided. The tubular inner sleeve member of the multicomponent tubular innermost sleeve assembly and the tubular outermost sleeve are each rigidly or securably connected to a separate frame or vehicle component part.

It is primary object of this invention is to maximize durability and minimize noise and clatter in an isolation bearing that allows for free torsional motion. It is another object of this invention to be used with heavy loads. Yet another object is to avoid the use of plastic inserts. By minimizing the torsional rigidity of the isolation bearing, advantages such as the lowering of a vehicle's effective unsprung weight may be achieved in some applications.

### BRIEF DISCUSSION OF THE DRAWINGS

FIG. 1 is a cross-sectional view of the limited torque isolation bearing in accordance with the present invention.

FIG. 2 is a blow-up of the cross-sectional view, enlarging the details of the threadable interconnection of the multicomponent tubular innermost sleeve assembly of the limited torque isolation bearing as well as the details of the voids for the threadable interconnection that arise as a result of flattening, milling or truncating the threads that are used to form the voids.

FIG. 3 is an end view of the limited torque isolation bearing in accordance with the present invention.

FIG. 4 is a cross-sectional view of an alternative embodiment of the limited torque isolation bearing in accordance with the present invention.

### DETAILED DESCRIPTION OF THE INVENTION

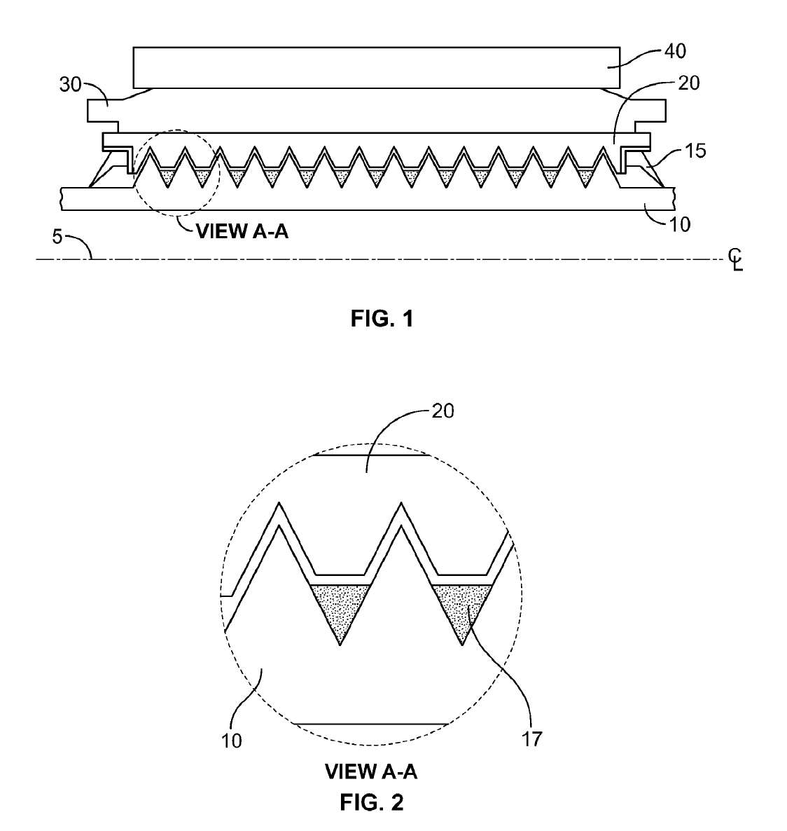

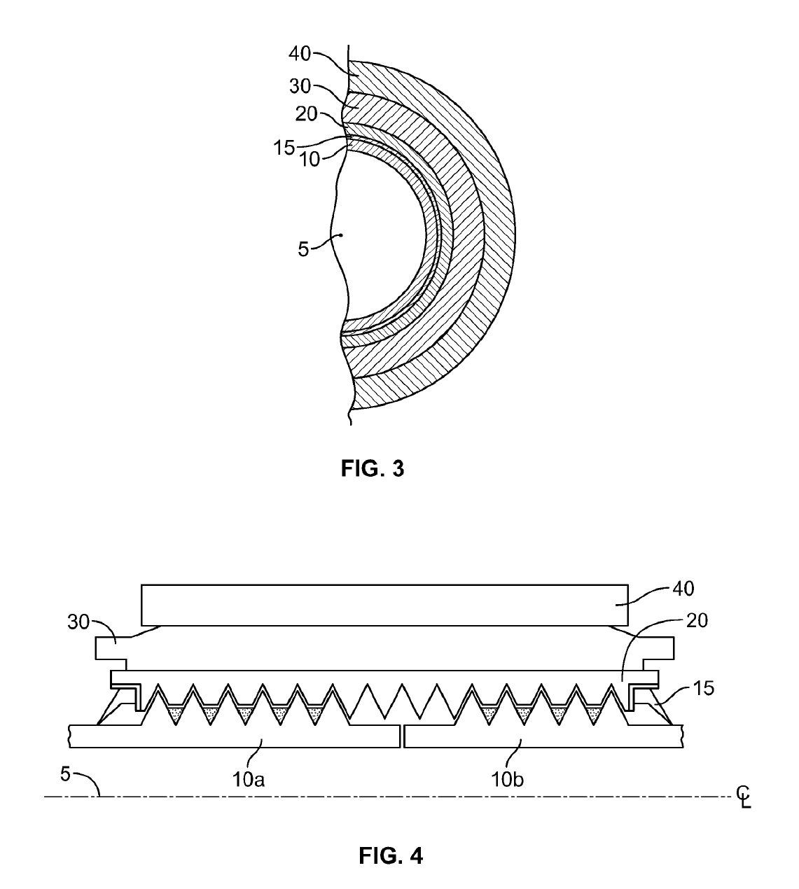

FIG. 1 is a cross-sectional view of the limited torque isolation bearing in accordance with the invention, showing, inter alia, the tubular outermost sleeve 40. FIG. 3 is an end view of the limited torque bearing of the present invention in which the end view of FIG. 3 is taken at a right angle to the plane of the cross sectional view of FIG. 1. Sleeve 40 is a tubular metal sleeve, or it may be a component part of the vehicle, such as a receiver for a shock absorber or spring, or the receiver at the attachment point for a lower control arm portion of a lower control arm assembly at the frame, or such other and similar locations as one skilled in the art would appreciate.

Multicomponent innermost sleeve assembly comprises a tubular inner threaded sleeve 10, and a tubular outer threaded sleeve 20, which are threadably interconnected together. An elastic component 30 is at least partially compression fitted therein between tubular outermost sleeve 40 and tubular outer sleeve member 20 of the innermost threaded sleeve assembly. Elastic components such as rubber, neoprene, and the like may be utilized in this application for elastic component 30 as one skilled in the art would appreciate.

As shown in FIG. 1, the multicomponent tubular innermost sleeve assembly comprises a tubular inner sleeve member 10 and a tubular outer sleeve member 20 that are threadably interconnected, which threadable interconnection contains at least some void space to allow for and accept a lubricant 17. In one embodiment, as shown in FIG. 2, the threadable interconnection of tubular inner sleeve member 10 and tubular outer sleeve member 20 may include somewhat flattened, milled or truncated raised portions of the threads on either or both of the sleeve members to provide a void space for the inclusion of a lubricant 17. Other ways of creating void space between tubular inner sleeve member 10 and tubular outer sleeve member 20 of the multicomponent tubular innermost sleeve assembly would be well within the skill of one knowledgeable in the art.

In one embodiment of the present invention, the threaded interconnection of the tubular inner sleeve member 10 and tubular outer sleeve member 20 may also include a non-threaded portion to create additional void space and allow space for lubricant 17. In such an embodiment, a threaded portion is placed at each end of the tubular sleeve members 10 and 20 having at least a plurality of threads and a flat coplanar cylindrical smooth portion therein between. It is believed that a minimum of 3 to 4 threads be used at each end of members 10 and 20 to avoid clashing or chatter. Lubricant 17 may be graphite or a suitable high molecular weight bearing or ball joint grease.

In another embodiment of the present invention, tubular inner sleeve member 10 having a non-threaded portion comprises two separate horizontally adjacent pieces 10(a) and 10(b) as shown in FIG. 4. In such an embodiment, the flat cylindrical portion allows for additional lubricant, while having a tubular inner sleeve member that comprises multiple horizontally adjacent segments 10(a) and 10(b) that significantly reduce thread lash and reduce noise. Using this multiple piece design allows for the application of a rotational offset or torque or bias between elements 10(a) and 10(b) which may significantly reduce the thread gaps between tubular inner sleeve members and tubular outer sleeve member 20. Enough torque or bias is applied to elements 10(a) and 10(b) to significantly reduce the thread lash, but not so much as to increase rotational resistance between elements 10 and 20.

Sealing means 15 are also provided to minimize the loss of the lubricant 17. Sealing means such as neoprene, nitrile, rubber, or other gasket type material are all well known in the art. Constructed in this manner, the lubricated threadable interconnection allows for free torsional motion of the tubular inner member 10 relative to the tubular outer sleeve member 20 of the innermost sleeve assembly which results in a frictionless, limited torque isolation bearing. Additionally, any axial motion of the tubular inner sleeve member 10 relative to the tubular outer sleeve member 20 of the innermost sleeve assembly (specifically, translational motion of one relative to the other along centerline 5), is minimized, providing a more stable limited torque isolation bearing.

In actual use and as an example, the limited torque isolation bearing is attached to a vehicle as follows: the tubular outermost sleeve 40 is rigidly connected to a frame element or component part of the vehicle and the tubular inner sleeve member 10 of the innermost sleeve assembly is likewise rigidly secured to a second frame element or component part of the vehicle. Tubular inner sleeve member 10 is typically secured by the use of a threaded bolt connection, which applies pressure to the ends of the frame or component part which thereby securably holds the tubular inner sleeve member 10 of the innermost sleeve assembly.

As indicated above, the torsional stiffness for conventional, well-known devices fall in the range of about 3600 to 3800 N-m/deg. When these well-known conventional devices are used as the attachment point for the lower control arm of a control arm assembly with the frame of a modern vehicle, this torsional rigidity effectively translates into an “effective” or “virtual” additional load of over 5 lbs. per wheel of unsprung weight. But when the device of the instant invention, as an example, is used as the attachment point for the lower control arm of a control arm assembly with the frame of a modern vehicle (with outermost sleeve 40 secured to the frame of the vehicle and innermost sleeve member 10 secured to the lower control arm) the torsional stiffness is in the range of less than about 10 N-m/deg. and preferably only about 1.5 to about 3.5 N-m/deg, which resistance is attributed to the resistance of sealing means 15 as it provides some frictional resistance to the torsional rotation of the tubular inner sleeve member 10 of the innermost sleeve assembly relative to the tubular outer sleeve member 20 of the innermost threaded sleeve assembly. As is well known, having less unsprung weight improves overall ride and handling.

As one skilled in the art would appreciate, the limited torque isolation bearings of the present invention may be used in the example mentioned, as the attachment point of the lower control arm of a vehicle with the frame. It may also be used in many other applications as we, including in leaf spring eye bushings, in spring shackles and in suspension links.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. A limited torque isolation bearing allowing rotational motion, for use in such applications as vehicle suspensions, comprising in concentric combination:
a tubular outermost sleeve;
a multicomponent innermost sleeve assembly comprising a tubular inner sleeve member and a tubular outer sleeve member which are threadably interconnected; and
an elastic component fitted therein between.

2. The limited torque isolation bearing of claim 1 wherein the multicomponent innermost sleeve assembly further comprises:
at least one void space;
a lubricant means for at least partial filling said void space; and
a sealing means for sealing said lubricant in said void space.

3. The limited torque isolation bearing of claim 2 wherein the tubular inner sleeve member consists of at least two horizontally adjacent members each of which is threaded.

4. The limited torque isolation bearing of claim 1, wherein said tubular outermost sleeve further comprises a tubular metal sleeve.

5. The limited torque isolation bearing of claim 1, wherein said threaded interconnection of the tubular inner sleeve member and tubular outer sleeve member further comprises a non-threaded portion such as to form additional void space therein between wherein said additional void space is adapted for receiving lubricant.

6. The limited torque isolation bearing of claim 5, wherein said non-threaded portion comprises a flat coplanar cylindrical smooth portion.

7. The limited torque isolation bearing of claim 5, wherein said void space comprises a flattened, milled or truncated raised portions of the threads on either or both of the sleeve members for forming said void space.

8. The limited torque isolation bearing of claim 5, wherein said lubricant means is selected from the group consisting of: graphite, high molecular weight bearing grease, and ball joint grease.

9. The limited torque isolation bearing of claim 5, wherein said sealing means is formed of a material selected from the group consisting of: neoprene, nitrile, rubber, and other gasket type material.

10. The limited torque isolation bearing of claim 5, wherein the outermost sleeve and the innermost sleeve allow rotational motion between said outermost sleeve and said innermost sleeve in a manner that resistance to torsional motion is less than about 10 N-m/deg.

11. The limited torque isolation bearing of claim 5, wherein said tubular metal sleeve further comprises a component part of a vehicle.

12. The limited torque isolation bearing of claim 11, wherein said component part of a vehicle is selected from the group consisting of: a receiver for a shock absorber, a receiver for a spring, and a receiver at the attachment point for a lower control arm portion of a lower control arm assembly at the frame.

13. The limited torque isolation bearing of claim 1, wherein said elastic component is selected from the group consisting of: rubber and neoprene.

14. A limited torque isolation bearing allowing rotational motion comprising in concentric combination:
a tubular outermost sleeve;
a multicomponent innermost sleeve assembly;
an elastic component fitted therein between;
wherein the multicomponent innermost sleeve assembly comprises a tubular inner sleeve member and a tubular outer sleeve member which are threadably interconnected utilizing a plurality of threads and wherein the multicomponent innermost sleeve assembly further comprises:
at least one void space;
a lubricant means for at least partial filling said void space; and
a sealing means for sealing said lubricant in said void space;
wherein the tubular inner sleeve member consists of at least two horizontally adjacent members, each of which is threaded.

15. The limited torque isolation bearing of claim 14, wherein the outermost sleeve and the innermost sleeve allow rotational motion between said outermost sleeve and said innermost sleeve in a manner that resistance to torsional motion is less than about 10 N-m/deg.

16. A method for isolating torque and allowing rotational motion in bearings having concentric combinations of components, said method comprising the steps:
a. Obtaining a tubular outermost sleeve forming a tubular inner cavity;
b. Fitting an elastic component within said tubular inner cavity; and
c. Inserting a multicomponent tubular innermost sleeve assembly within said tubular outmost sleeve thereby containing said elastic component therein between.

17. The method of claim 16, wherein said multicomponent tubular innermost sleeve assembly comprises a tubular inner sleeve member and a tubular outer sleeve member which are threadably interconnected.

18. The method of claim 17, wherein said threadable interconnection contains at least some void space to allow for and accept a lubricant.

19. The method of claim 18, further comprising the step:
d. Placing a lubricant into said void space.

20. The method of claim 17, wherein said threadable interconnection of a tubular inner sleeve member and a tubular outer sleeve member further comprises a flattened, milled or truncated raised portions of the threads on either or both of the sleeve members for forming said void space.
